(19) United States
(12) Patent Application Publication
(10) Pub. No.: US 2014/0152439 A1
(43) Pub. Date: Jun. 5, 2014

(54) Security System

(71) Applicant: James H. Nguyen, Indianapolis, IN (US)

(72) Inventor: James H. Nguyen, Indianapolis, IN (US)

(21) Appl. No.: 13/694,428

(22) Filed: Dec. 3, 2012

(51) Int. Cl. G08B 15/00

(52) U.S. Cl. CPC G08B 15/00
USPC 340/541

(57) ABSTRACT

A security system and method which includes a main automatically acting circuit 10 and portions which may be manually activated by a user to provide better deterrence to a home invader or burglar (11-14). The manually activated portions turn on an audible alarm and/or lights which may or may not be in the automatic section. Thus, economy of manufacture with enhanced safety and security is achieved. A variable alarm system is thus presented to a potential intruder to more effectively terminate a possible home invasion or robbery. The method includes remote control devices and remote detection devices so a user can remotely stop a home invasion or burglary.

### BACKGROUND AND OBJECTS OF THE INVENTION

The present invention is generally related to the home security arts and, in particular, to a novel system and method of use for the occupants and owners of a home which may be threatened.

Prior art systems and methods have proven to be somewhat useful but have not proven to provide sufficient warning and options for action to the inhabitants of a home threatened with unlawful entry.

Prior art systems have also not proven to be economical for widespread manufacture and not especially useful for panicked inhabitants of a home being threatened.

Accordingly, it is an object of the present invention to set forth a novel home security system which sufficiently warns the occupants of a home being threatened.

It is a further object to demonstrate a method which gives the home occupants multiple options for responding to a dangerous situation, such options being readily used by persons of any age or physical condition.

It is also an object of the invention to show a system which may be economically manufactured for widespread commercial appeal and use.

These and other objects and advantages of the present invention will be apparent to those of skill in the home security and related arts.

### PRIOR ART PATENTS AND DESIGNS

During the course of preparing this document for submission to the U.S. Patent and Trademark Office, a full search of the prior art was conducted.

The following United States Patents are considered to be broadly relevant to applicant's design:
U.S. Pat. No. 6,309,090 issued to Tukin in 2001,
U.S. Pat. No. 6,927,541 issued to Lee in 2005.

Both show lighting and alarm systems of a general nature.

Importantly, the design submitted by James Nguyen herein is clearly patentable over all known systems and is believed by the undersigned attorney to be a MAJOR BREAKTHROUGH in the home security and related technical arts.

Other internet searches and comparative shopping searches were made in detail and the invention is is clearly patentable over all known methods and systems used in the art.

### BRIEF DESCRIPTION OF THE DRAWING FIGURES

FIG. 1 is a top schematic view of a home with security lighting elements placed at various locations.

FIG. 2 shows a logic diagram of various critical operating features of the invention.

FIG. 3 is a schematic view of various remote control elements of the invention. These are critical features of the design since they allow enhanced control by a threatened home occupant.

### FULL DESCRIPTION OF THE PREFERRED EMBODIMENTS

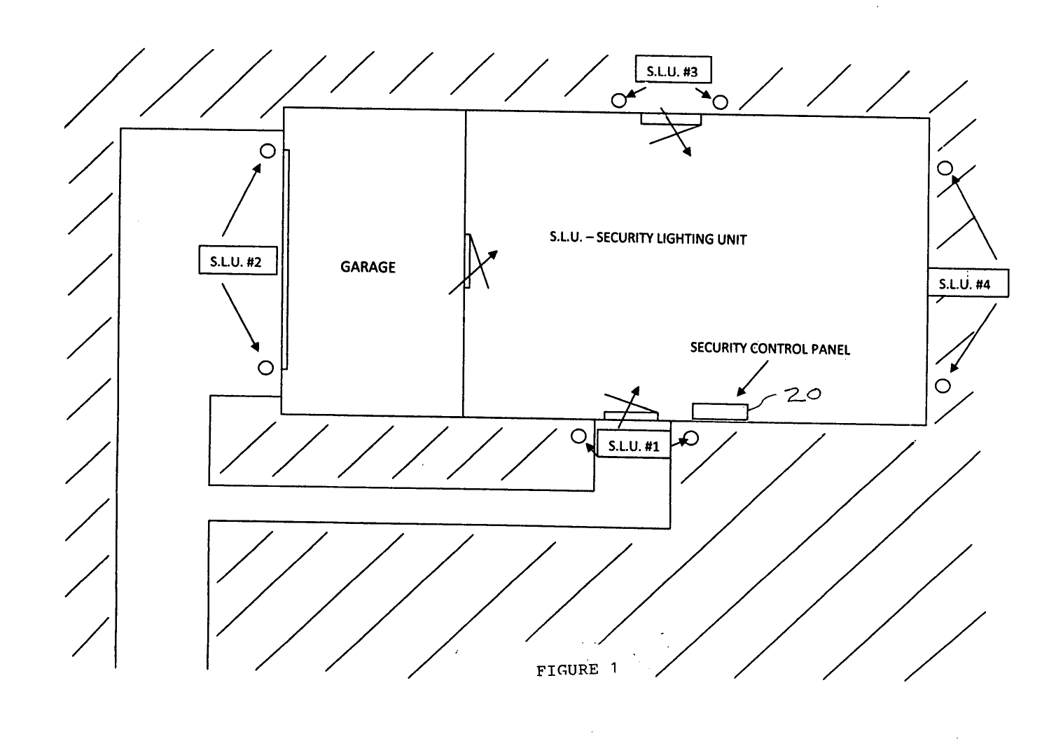

FIG. 1 is a top schematic view of a typical home having security lighting units (SLU's) placed at the following locations:
at the front door of the home,
at the main garage door of the home,
at a rear location of the house,
at a side or end location of the home.

The security lighting units may be placed at various other locations of the home as decided by the homeowner. Also, they may be placed at various locations on the grounds at the option of the system users.

A security control panel (SCP) is indicated schematically near the front door of the home. The SCP will be more fully described herein.

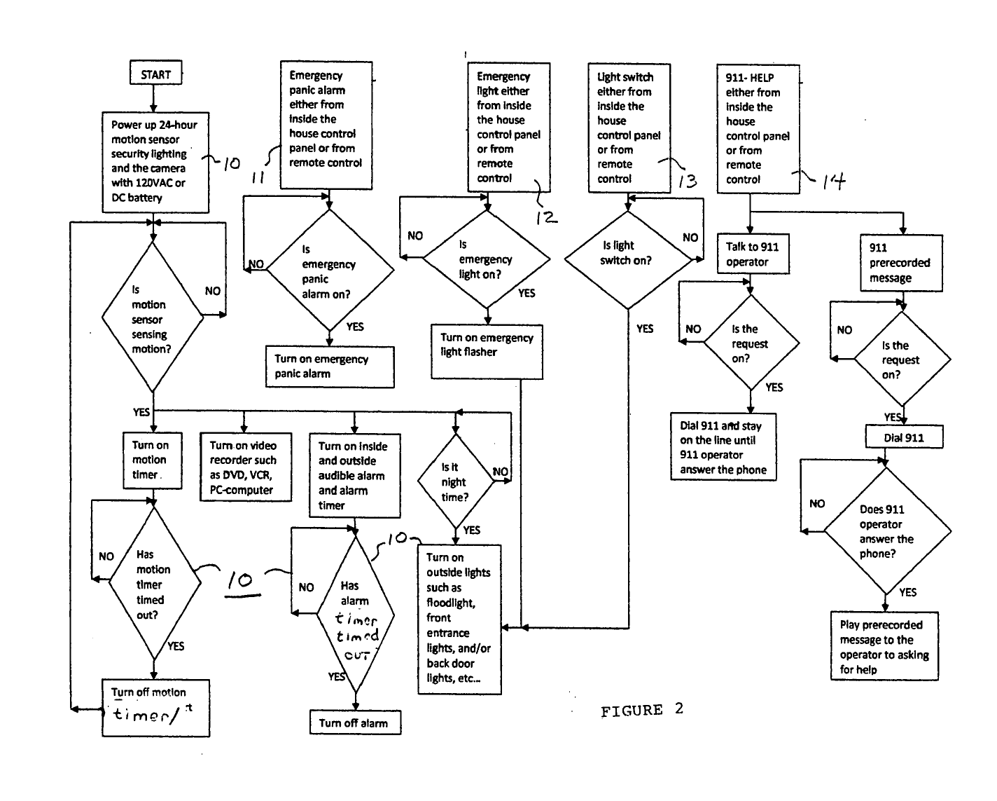

Referring to the drawing FIG. 2, the basic security lighting system operation is shown at the left and lower left of the figure. It includes motion sensors, security lights and cameras and various operational blocks as shown.

Referring further to the left hand portion of FIG. 2, it is seen that if a motion sensor is detecting motion, the following operations are performed:
turn on motion timer,
turn on video recorder unit or units at the desired setup choice of a home owner,
turn on INSIDE and OUTSIDE audible alarms,
turn on outside lights such as floodlights etc. at the setup choice of a home owner.

As further indicated in FIG. 2, the system can shut off motion timers and alarms after a certain time.

The above-described system is very powerful by itself to deter possible intruders, home invaders or burglars.

However, when it interfaces with other remote control devices to be described, it becomes a formidable NETWORK that provides a complete outside home security system and method of use.

FIG. 2 shows further critical aspects of the invention which enable a person being subject to a possible home invasion to set off further alarm elements.

Looking across the top of FIG. 2, the further alarm elements are as follows:
emergency panic alarm operated via the home control panel or from a remote control device,
emergency light flasher means operated via the control panel or remote control,
a light switch operated via the control panel or by remote control means,
a 911-HELP button operated on the house control panel or via remote control.

The main automatically acting circuit indicated at numeral 10 is at the left and lower left of FIG. 2. The emergency panic alarm at numeral 11 is optionally activated by the user—it may be independent as shown or connected to the main circuit 10. The lighting circuits 12 and 13 are optionally activated by the user and are shown as connected to the main circuit 10—circuit 12 includes an emergency flasher. The 911-HELP circuit 14 is independent and optionally activated by the user.

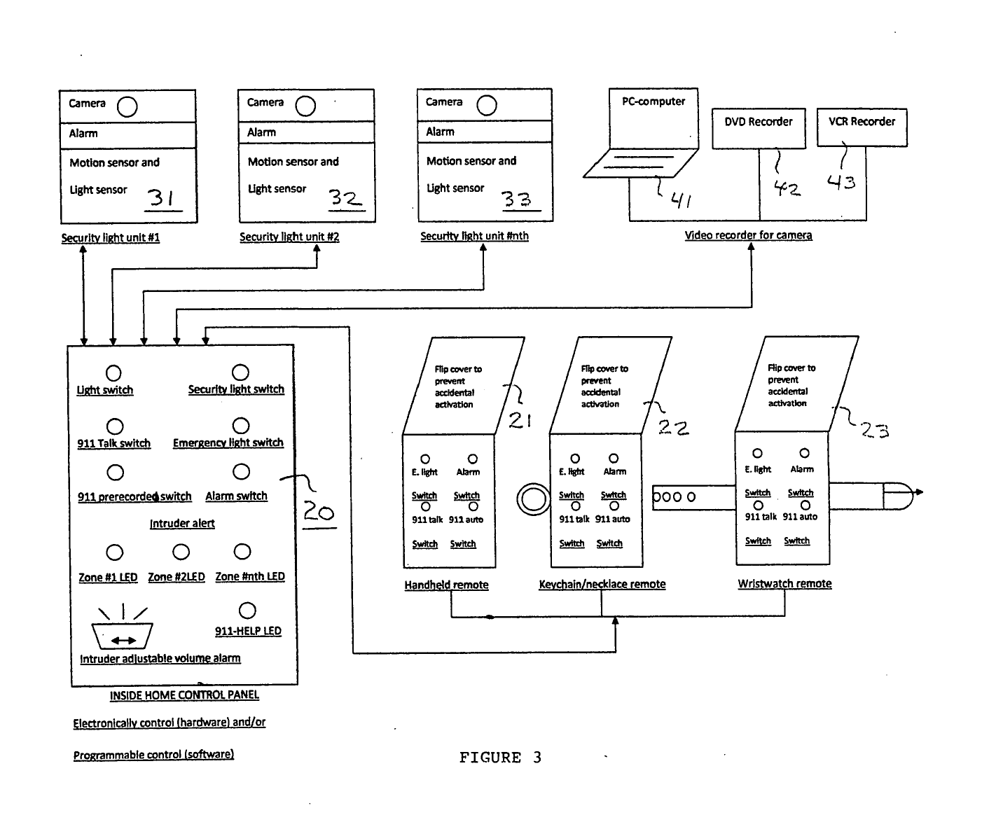

FIG. 3 shows the inside home security control panel 20 which is also shown at the front door area of FIG. 1.

As shown in FIG. 3, the control panel 20 has various buttons which may be activated by a user of the device to activate such circuits as the emergency lights and/or audible alarm.

Feeding into the control panel 20, there are remote units so that a user does not have to stand at the front door to operate the main control panel.

The remote units are shown in FIG. 3 as follows:
handheld flip-cover remote 21,
keychain/necklace remote at numeral 22,
wristwatch remote also with a flip cover at numeral 23.

Various cameras positioned about the property are indicated at numerals 31, 32 and 33.

Numeral 41 indicates a remote Computer by which a person can view what is happening and activate the desired alarms to thwart a home invasion. Recorders 42 and 43 are also connected to the cameras and control panel.

While particular systems and methods of use have been shown and described, it is intended in this specification to broadly cover all equivalent systems and methods which would reasonably occur to those of skill in the security arts. For example only, the particular steps and logic systems may be varied so long as there is a network of automatic and manual panic-type elements to provide the maximum deterrence for a home being attacked.

The invention is further defined by the claims included herewith.

I claim:

1. A security method for protecting a home or other environment comprising the steps of:
A) providing a main automatic circuit (10) having motion detector means for activating an audible alarm and a security light in an automatic fashion,
B) providing a panic emergency alarm (11) means which is activated manually by a user to turn on an audible alarm and provide further deterrence to a would-be intruder or burglar,
C) providing an emergency light flasher (12) means which is manually activated by the user to turn turn on flashing security lights,
D) providing that the method uses both automatic deterrence and manually activated deterrence means to provide the in-home persons with enhanced security.

2. The method of claim 1 and further including the step of providing a 911HELP button which the user can activate for enhanced security.

3. A security system for a home or other areas to be protected including the following elements:
A) an automatic warning electronic circuit means (10) including warning lights and audible interior and exterior sounds and which includes camera and motion sensor means to deter a possible home invader,
B) manually activated electronic circuit means (11,12) for setting off extra flashing lights and extra warning sounds, such being activated by a person in a home being attacked or threatened,
C) further manually activated means (13) for setting off extra floodlights to alert police and neighbors to the emergency situation,
D) further manually activated means (14) for dialing 911-HELP line and either speaking directly to a help provider or leaving a prerecorded message that help is urgently needed by a home dweller.

4. The system of claim 3 and further including a control panel (20), remote control means (21,22,23), cameras (31,32,33) and recording means (41,42,43).

5. A series of security method steps for protecting a home and persons therein comprising:
A) providing an inside home control panel (20) means which responds automatically to sensors located outside the home,
B) providing that said inside home control panel also responds to remote manually operated means and generates extra warning signals to effectively scare off a would-be intruder.

6. The method of claim 5 wherein the inside home control panel (20) activates video recorders (42,43) to record intruder activity.

7. The method of claim 6 wherein the inside home control panel also signals a remote computer (41) so that a user is appropriately notified.
